(19) United States
(12) Patent Application Publication
(10) Pub. No.: US 2004/0020426 A1
(43) Pub. Date: Feb. 5, 2004

(54) Dispensing methods and apparatus for in-line addition of colorants and/or additives to finish products applied to vehicles

(76) Inventors: Paul J. Mattia, Prior Lake, MN (US); Terry J. Klos, Victoria, MN (US); Michael E. Besse, Golden Valley, MN (US); Jerry D. Hoyt, Hastings, MN (US)

Correspondence Address: IPLM GROUP, P.A., POST OFFICE BOX 18455, MINNEAPOLIS, MN, 55418, US

(21) Appl. No.: 10/427,270

(22) Filed: May 1, 2003

Related U.S. Application Data
(60) Provisional application No. 60/401,296, filed on Aug. 2, 2002.

(51) Int. Cl. B05D 1/02; B05C 5/00

(52) U.S. Cl. 118/300; 427/421; 118/323

(57) ABSTRACT

A method and apparatus for dispensing a finish product with the concurrent in-line addition of an additive to the finish product onto vehicles in a vehicle wash station includes providing a base product, adding the additive to the base product to create a resultant solution, and applying the resultant solution to the vehicle.

This application claims the benefit of U.S. Provisional Application No. 60/401,296, filed Aug. 2, 2002.

### BACKGROUND OF THE INVENTION

1. Field of the Invention

The present invention relates to the application of finish products to outer surfaces of vehicle components, and more specifically, to methods and apparatus for dispensing such finish products with in-line addition of colorants and/or additives onto vehicles in a vehicle car wash.

2. Description of the Prior Art

In the car wash industry, vehicle finish products may be applied to enhance the appearance and to prevent corrosion of vehicles. Such finish products often contain dyes, fragrances, and/or other additives to augment the products, and these are often used to differentiate between competing car washes.

The current practice is to apply 0.2 to 1.0 ounces of multiple protectants onto the outer surface of vehicles in car washes. The most common application is three different colors of a chosen product. For example, a car wash keeps a red, a blue, and a yellow drum of protectant and typically concurrently injects each of them separately onto the vehicles. The products have very high concentrations of dye in them (about 2% to 4% dye), but are otherwise identical. This requires large areas of space to store each of the drums. Also, when the product levels are low in the drums, it is common to pour the remaining product into another drum, and spilling of the product often occurs. Because of the high concentrations of dye in the products, the dye often stains the floor and surrounding items that come into contact with the products. Examples of various protectants used in car washes include Spectra Shine Triple Color Polish with Clear Coat Protectant, Poly Shell Triple Shine, and Triple Coat Wax, although this list of examples is not exhaustive.

### SUMMARY OF THE INVENTION

In a preferred embodiment method for adding an additive to a vehicle finish product concurrent with application onto vehicles in a vehicle wash station, a first container holding a vehicle finish product and a second container holding an additive are provided. The first container is operatively connected to a source of water whereby the first container is in fluid communication with the source of water thereby diluting the vehicle finish product with water to create a first resultant solution. The first resultant solution is combined with the additive to create a second resultant solution, and the second resultant solution is applied directly onto the vehicles in the vehicle wash station.

In a preferred embodiment method for dispensing an additive with a vehicle finish product applied to vehicles in a vehicle wash station, a first container holding a first concentrated solution operatively connected to a water source. Then, water is conveyed from the water source thereby combining the first concentrated solution and water to create a first resultant solution. A second container holding a second concentrated solution is placed in fluid communication with the first resultant solution. The first resultant solution and said second concentrated solution are combined to create a second resultant solution, and dispensation of said second resultant solution is facilitated in atomized form onto the vehicles in the vehicle wash station.

In a preferred embodiment system for dispensing an additive with a vehicle finish product, a first container for holding a vehicle finish product is in fluid communication with a water source, wherein water combines with the vehicle finish product to form a first resultant solution. A second container for holding an additive is held in a dispenser having a reservoir, wherein additive empties into the reservoir. The second container is readily replaceable to replenish additive within the reservoir. An injection system is operatively connected to the dispenser to add additive from the reservoir to the first resultant solution to form a second resultant solution.

In a preferred embodiment method for applying an additive with a finish product to vehicles in a vehicle wash station, a first container holding a product solution, a second container holding a first additive solution, and a third container holding a second additive solution are provided. Water and the product solution are combined to create a first resultant solution. The first resultant solution is combined with the first additive solution to create a second resultant solution, and the first resultant solution is combined with the second additive solution to create a third resultant solution. The second resultant solution and the third resultant solution are applied onto the vehicles in the vehicle wash station.

In a preferred embodiment method for adding an additive to a vehicle finish product concurrent with application onto vehicles in a vehicle wash station, a first container holding an additive solution and a second container holding a finish product solution are provided. Water and the additive solution are combined to create a first resultant solution, and the first resultant solution is combined with the product solution to create a second resultant solution. The second resultant solution is applied onto the vehicles in the vehicle wash station.

In a preferred embodiment system for dispensing a discrete vehicle finish product with an additive in proximity to a vehicle in a vehicle wash station, a first container holding a first solution is in fluid communication with a water supply. A first supplying means is operatively connected to the first container for supplying the first solution to the water supply thereby combining the first solution with water to create a first resultant product. The second container is in fluid communication with a conduit. A second supplying means is operatively connected to a second container holding a second solution, and the second supplying means supplies the second solution to the first resultant product thereby combining the second solution and the first resultant product to create a second resultant product. A spray device operatively connected to the conduit and atomizing means on the conduit are provided for atomizing the second resultant product as it exits the spray device onto the vehicle.

In a preferred embodiment apparatus for applying an additive with a vehicle finish product onto vehicles, a first container for holding a product is in fluid communication with a water source, wherein water combines with the product to form a first resultant solution. A second container for holding a first additive and a third container for holding a second additive are also provided. A first dispenser holds the second container, wherein the second container is readily replaceable to replenish the first additive within the first dispenser. A second dispenser holds the third container, wherein the third container is readily replaceable to replenish the second additive within the second dispenser. A first injection system is operatively connected to the first dispenser, and the first injection system adds the first additive from the first dispenser to the first resultant solution to form a second resultant solution. A second injection system is operatively connected to the second dispenser, and the second injection system adds the second additive from the second dispenser to the first resultant solution to form a third resultant solution.

In a preferred embodiment method for dispensing and applying a dye with a finish product onto a surface of a vehicle in a vehicle wash station, a first container holding a finish product solution and a second container holding a dye solution are provided. Water is combined with the finish product solution to create a first resultant solution, and the first resultant solution is combined with the dye solution to create a second resultant solution. The second resultant solution is applied onto the vehicles in the vehicle wash station.

In a preferred embodiment apparatus for dispensing a dye with a base product, a product container holding a base product, a first dye container holding a first dye, a first dye injector, and a water source are provided. Water from the water source combines with the base product to create a first resultant solution. A pump pumps the first resultant solution to the first dye injector, wherein the first dye from the first dye container combines with the first resultant solution to create a second resultant solution. An application member applies the second resultant solution onto vehicles in a vehicle wash station.

### BRIEF DESCRIPTION OF THE DRAWINGS

FIG. 1 is a schematic view of a dispensing system for use in a vehicle wash station constructed according to the principles of the present invention;

FIG. 2 is an exploded perspective view of a product reservoir for use with the dispensing system shown in FIG. 1; and

FIG. 3 is a schematic view of a prior art dispensing system for use in a vehicle wash station.

### DETAILED DESCRIPTION OF THE PREFERRED EMBODIMENT

An embodiment of the present invention is designated by the numeral 10 in the drawings. The dispensing system 10 may be described as a self-contained coating system designed to apply finish products to outer surfaces of vehicles in a vehicle wash station. The depicted dispensing system 10 selectively dispenses one or more finish products onto the vehicles.

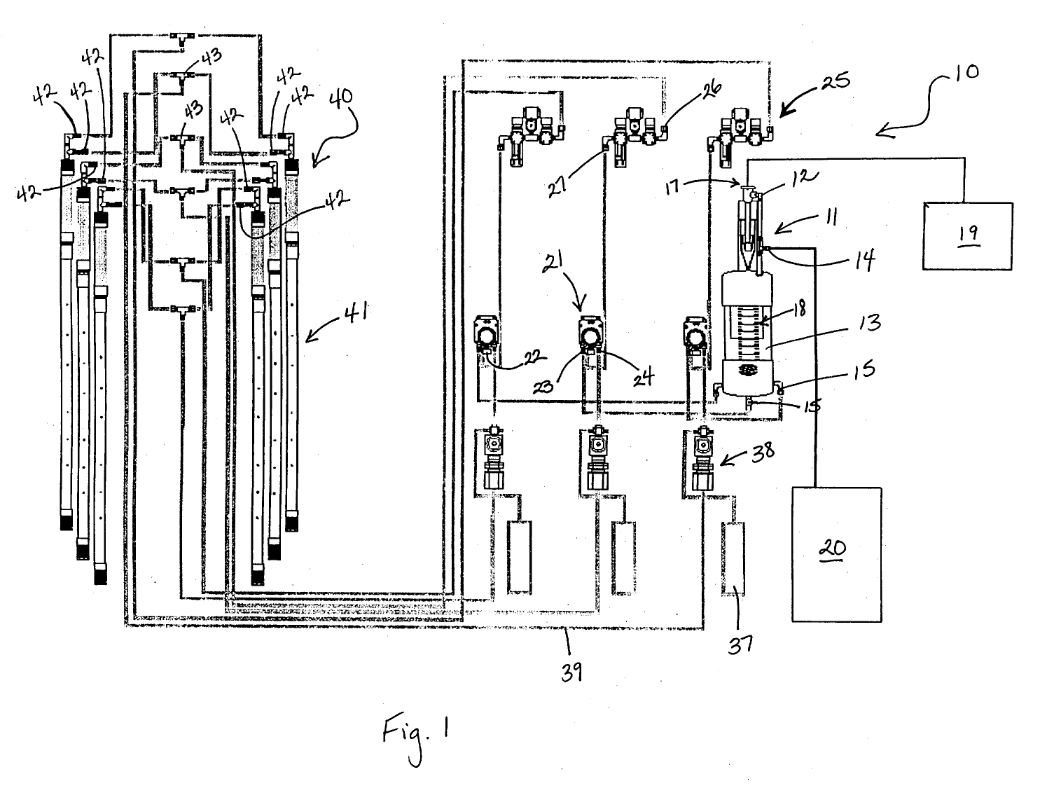

As shown in FIG. 1, the dispensing system 10 generally includes a product container 20 holding a base finish product, a dilution chamber 11, an air regulator 25, a pump 21, an additive container 37 holding an additive, an additive injector 38, and a foam generator 40.

The base product can be in either solid or liquid form, and the base product includes the desired finish product to be applied to outer surfaces of vehicles in the vehicle wash station. Such a base product could be Harmony Triple Coat Conditioner™ or Harmony Clear Coat Polish™ manufactured by Ecolab Inc., however it is recognized that other finish products well known in the art could be used as well. If the base product is in solid form, a flood dispenser of the type well known in the art may be used to create a product use solution. Also, water may be sprayed onto the product to form a product use solution. If the base product is in liquid form, it could either be used directly or it may be diluted if it is in a concentrated form.

If the base product is in a concentrated liquid form, the dilution chamber 11 is the supplying means that dilutes the base product and dispenses the diluted base product use solution to the remaining components in the system 10. Any suitable dilution chamber well known in the art may be used. The dilution chamber 11 of the preferred embodiment includes a hydrominder 12, which is an automatic liquid level control proportioner that keeps the reservoir 13 filled with consistently mixed resultant use solution and is well known in the art. The hydrominder 12 includes a base product feed 14 and water injection inlet 17. As water from a water source 19 is drawn into the water injection inlet 17 near the top of the hydrominder 12, base product 20 is drawn into the stream of water through an aspirator near the side of the hydrominder 12. The base product is appropriately diluted and mixed within the hydrominder 12, and the ready to use product use solution is dispensed through the outlets 15. A float 18 controls the product use solution level within the reservoir 13. Although the preferred embodiment utilizes one dilution chamber 11, it is recognized that any number of dilution chambers 11 may be utilized. However if space is limited, it would be preferred to utilize just one dilution chamber 11.

After the resultant use solution has been created within the reservoir 13, the use solution is discharged from at least one of the outlets 15 and then conveyed to the corresponding additive injector 38, where additive is then injected into the use solution, by the corresponding pump 21. The additive injectors 38 act as supplying means to dispense additive into the use solution thereby creating a second use solution. The pumps 21 of the preferred embodiment are air diaphragm pumps having an air inlet 22, a fluid inlet 23, and a fluid outlet 24. Although an air pump is shown, other suitable pumps well known in the art may be used. If air pumps are utilized, air regulators 25 control the pumps 21 and provide them with air. Although the preferred embodiment utilizes an air regulator for each corresponding pump, it is possible to utilize a single air regulator having air valves for each pump. However, the system is more reliable if there is an air regulator for each pump because the pumps are easier to tune if separate air regulators are tuned individually. The air regulators 25 have an air outlet 26 and an air outlet 27. The air outlet 26 provides air to the foam generator 40 and the air outlet 27 provides air to the pumps 21. Air mixes with the product use solution to generate foam, and air generates foam in the foam generator 40 and helps propel the foam onto the vehicle.

The additive is added to supplement the base product to create a resultant solution. Therefore, rather than having several containers of base product containing different additives, one base product is used and supplemented with different additives concurrent with application of the base product thereby reducing the storage area required for such a system. The additive could be in either solid or liquid form, and the additive could be a concentrated product in a smaller container relative to the base product thereby saving space even though multiple additive containers could be used. Various types of additives that may be used include dyes, drying agents, waxes, protectants, polishes, UV protection agents, and fragrances.

If the additive is in solid form, a flood dispenser could be used to dispense the use solution. Also, the solid product could be sprayed with water to create the use solution, which would then be added to the base product. However, any suitable dispensing means well known in the art could be used to dispense the solid product.

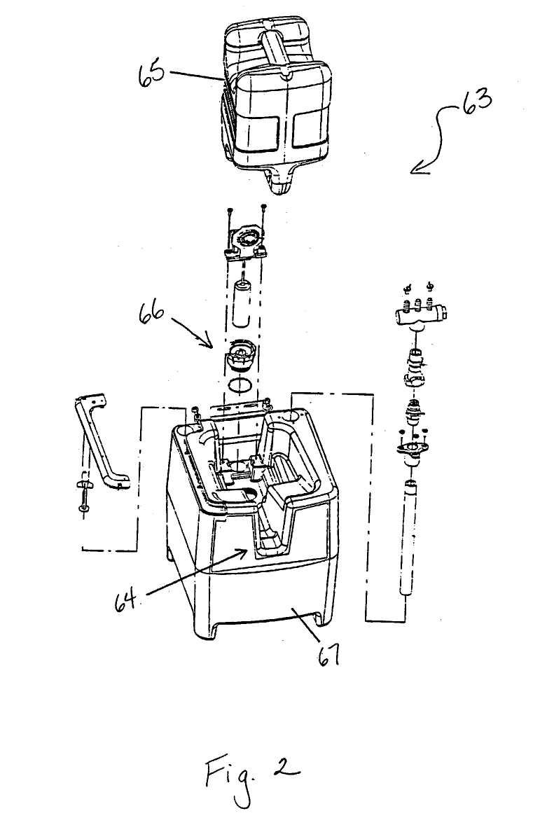

If the additive is in liquid form, an enclosed dispensing system could be used to reduce spillage. In one possible embodiment, one type of product dispenser that could be used is shown in FIG. 2, which shows the AeroLite™ Reservoir by Ecolab Inc. A product reservoir dispenser 63 includes a docking station 64, which holds a container 65 of additive, and the additive empties into a reservoir 67 from which it is dispensed. A fitment or docking cup 66 may be used to ensure that the correct product is being utilized with the docking station 64 and to pierce the membrane on the container 65, which helps to reduce spillage of the product. The reservoir 67 eliminates the need to “top off” the product drum with the remaining product when the product level is getting low and therefore reduces the risk of spilling while pouring the remaining product into a fuller drum. The reservoir 67 may indicate when the product within container 65 is empty and should be replaced. In addition, the base product could also be dispensed by these supplying means.

Any suitable dispenser could be used to supply the base product and/or the additive to the system. However, the base product and the additive are mixed to create a resultant solution prior to the application point on the vehicle as the resultant solution is being applied to the vehicle. In other words, the additive is added to the base product in stream as the final supplemented base product is being dispensed and applied to the vehicle. If more than one additive is being utilized, the different additives could be applied concurrently or they could be intermittently pulsated to splash a variety of additives onto the vehicle surface. Several application patterns are possible for aesthetic purposes. Further, the order in which the base product and the additive are supplied to the system and mixed to create the resultant solution is not critical. Although the preferred embodiment shows the base product being supplied first, it is recognized that the additive may be supplied first and the base product added to the additive.

The additives may be easily substituted to allow application of different additives without wasting the base product or requiring additional storage space. For example, if the additive is a dye, the different dyes could be changed to correspond with various sports teams' colors, seasonal changes, or holidays. The additive could also be contained in systems such as Victory™ System, QC™ Ultra Concentrate Dispensing System, and Dynamix™ System by Ecolab Inc. and added in-line to the base products. It is recognized that other suitable dispensers well known in the art could be used with the present system.

A conduit 39 carries the supplemented base product including the additive(s) to a foam generator 40 via compression tees 43 and check valves 42. The compression tees 43 distribute the resultant solution (the supplemented base product including the additive(s)) to atomizing means 41 of the foam generator 40, and the check valves 42 regulate flow to the atomizing means 41. The foam generator 40 is an application member for dispensing the supplemented base product including the additive(s), which is applied to the exterior of the vehicle. The foam generator 40 includes a spray device and atomizing means 41 to apply the resultant solution onto the vehicles and is well known in the art of vehicle wash stations.

Alternatively, a single line could be used and the system could operate multiple times. The line should be cleared prior to each use to ensure that the additive did not mix with the previous additive. The simplest way to accomplish this would be to use a water flush such as a water valve proximate the top of the foam generator 40.

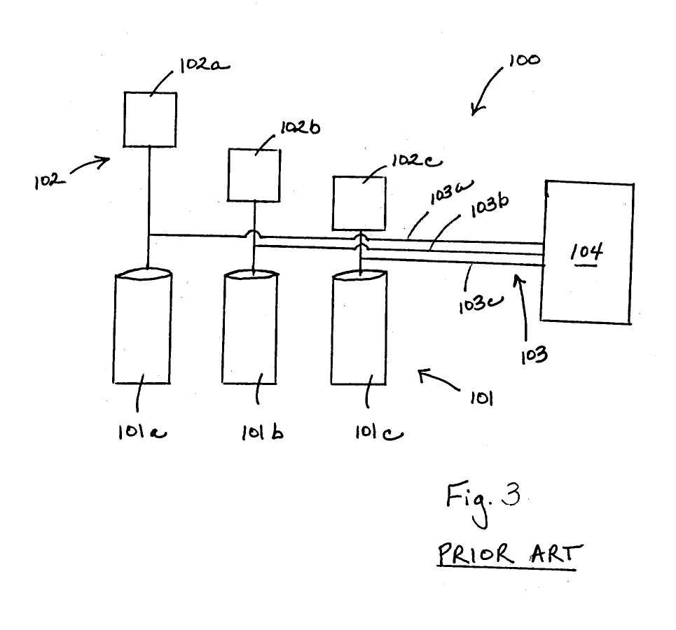

A prior art dispensing system 100, shown in FIG. 3, includes a product drum 101, a pump 102, a line 103, and foam sticks 104. Although any number of product drums 101 could be utilized, three product drums 101a, 101b, and 101c are shown. Each product drum contains a product including both base product and additive. Therefore, for every additive desired, another product drum 101 must be used with the dispensing system 100. Because multiple product drums 101 must be used, more space is required for the dispensing system 100. Pump 102a pumps water or water and air to create a use solution with the product contained in product drum 101a, and then the use solution is carried through line 103a to be dispensed through the foam sticks 104. Pump 102b pumps water or water and air to create a use solution with the product contained in product drum 101b, and then the use solution is carried through line 103b to be dispensed through the foam sticks 104. Similarly, pump 102c pumps water or water and air to create a use solution with the product contained in product drum 101c, and then the use solution is carried through line 103c to be dispensed through the foam sticks 104.

Advantages of the present invention include space savings, the ability to provide a variety of colors for unique presentation for seasonal changes, holidays, and sports teams, and the reduction of the risk of staining from spillage.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A method for adding an additive to a vehicle finish product concurrent with application onto vehicles in a vehicle wash station, comprising:
a) providing a first container holding a vehicle finish product;
b) providing a second container holding an additive;
c) operatively connecting said first container to a source of water whereby said first container is in fluid communication with said source of water thereby diluting said vehicle finish product with water to create a first resultant solution;
d) combining said first resultant solution with said additive to create a second resultant solution; and
e) applying said second resultant solution directly onto the vehicles in the vehicle wash station.

2. The method of claim 1, wherein said vehicle finish product is selected from the group consisting of a drying agent, a wax, a protectant, and a polish.

3. The method of claim 1, wherein said additive is selected from the group consisting of a dye, a fragrance, and an ultraviolet protectant.

4. The method of claim 1, wherein said vehicle finish product is in a solid form.

5. The method of claim 1, wherein said vehicle finish product is in a liquid form.

6. The method of claim 1, wherein said additive is in a solid form.

7. The method of claim 1, wherein said additive is in a liquid form.

8. The method of claim 1, further comprising:
a) providing a third container holding a second additive;
b) combining said first resultant solution with said second additive to create a third resultant solution; and
c) applying said third resultant solution onto the vehicles in the vehicle wash station.

9. The method of claim 8, wherein said second resultant solution and said third resultant solution are applied concurrently.

10. The method of claim 8, wherein said second resultant solution and said third resultant solution are pulsated intermittently.

11. A method for dispensing an additive with a vehicle finish product applied to vehicles in a vehicle wash station, comprising:
a) operatively connecting a first container holding a first concentrated solution to a water source;
b) conveying water from said water source thereby combining said first concentrated solution and water to create a first resultant solution;
c) placing a second container holding a second concentrated solution in fluid communication with said first resultant solution; and
d) combining said first resultant solution and said second concentrated solution to create a second resultant solution and facilitating dispensation of said second resultant solution in atomized form onto the vehicles in the vehicle wash station.

12. The method of claim 11, wherein said first concentrated solution is a vehicle finish product solution and said second concentrated solution is an additive solution.

13. The method of claim 11, wherein said first concentrated solution is an additive solution and said second concentrated solution is a vehicle finish product solution.

14. A system for dispensing an additive with a vehicle finish product, comprising:
a) a first container for holding a vehicle finish product;
b) a water source in fluid communication with said first container, wherein water combines with said vehicle finish product to form a first resultant solution;
c) a second container for holding an additive;
d) a dispenser having a reservoir, said dispenser holding said second container, wherein said additive empties into said reservoir, wherein said second container is readily replaceable to replenish said additive within said reservoir; and
e) an injection system operatively connected to said dispenser, said injection system adding said additive from said reservoir to said first resultant solution to form a second resultant solution.

15. The method of claim 15, wherein said additive is selected from the group consisting of a dye, a fragrance, and an ultraviolet protectant.

16. A method for applying an additive with a finish product to vehicles in a vehicle wash station, comprising:
a) providing a first container holding a product solution;
b) providing a second container holding a first additive solution;
c) providing a third container holding a second additive solution;
d) combining water with said product solution to create a first resultant solution;
e) combining said first resultant solution with said first additive solution to create a second resultant solution and combining said first resultant solution with said second additive solution to create a third resultant solution; and
f) applying said second resultant solution and said third resultant solution onto the vehicles in the vehicle wash station.

17. The method of claim 16, wherein said second resultant solution and said third resultant solution are applied concurrently.

18. The method of claim 16, wherein said second resultant solution and said third resultant solution are pulsated intermittently.

19. The method of claim 16, wherein said first additive solution and said second additive solution are selected from the group consisting of a dye, a fragrance, and an ultraviolet protectant.

20. A method for adding an additive to a vehicle finish product concurrent with application onto vehicles in a vehicle wash station, comprising:
a) providing a first container holding an additive solution;
b) providing a second container holding a finish product solution;
c) combining water with said additive solution to create a first resultant solution;
d) combining said first resultant solution with said product solution to create a second resultant solution; and
e) applying said second resultant solution onto the vehicles in the vehicle wash station.

21. The method of claim 20, further comprising:
a) providing a third container holding a second additive solution;
b) combining water with said second additive to create a third resultant solution; and
c) applying said third resultant solution onto the vehicles in the vehicle wash station.

22. The method of claim 21, further comprising applying said second resultant solution and said third resultant solution onto the vehicles in the vehicle wash station concurrently.

23. The method of claim 21, further comprising applying said second resultant solution and said third resultant solution onto the vehicles in the vehicle wash station intermittently.

24. A system for dispensing a discrete vehicle finish product with an additive in proximity to a vehicle in a vehicle wash station, comprising:
a) a first container holding a first solution;
b) a second container holding a second solution;
c) a water supply, wherein said first container is in fluid communication with said water supply;
d) a first supplying means operatively connected to said first container for supplying said first solution to said water supply thereby combining said first solution with water to create a first resultant product;
e) a conduit, wherein said second container is in fluid communication with said conduit;
f) a second supplying means operatively connected to said second container for supplying said second solution to said first resultant product thereby combining said second solution and said first resultant product to create a second resultant product;
g) a spray device operatively connected to said conduit; and
h) atomizing means on said conduit for atomizing said second resultant product as it exits said spray device onto the vehicle.

25. The system of claim 24, wherein said first solution is a product solution and said second solution is an additive solution.

26. The system of claim 24, wherein said first solution is an additive solution and said second solution is a product solution.

27. An apparatus for applying an additive with a vehicle finish product onto vehicles, comprising:
a) a first container for holding a product;
b) a water source in fluid communication with said first container, wherein water combines with said product to form a first resultant solution;
c) a second container for holding a first additive;
d) a third container for holding a second additive;
e) a first dispenser holding said second container, wherein said second container is readily replaceable to replenish said first additive within said first dispenser;
f) a second dispenser holding said third container, wherein said third container is readily replaceable to replenish said second additive within said second dispenser;
g) a first injection system operatively connected to said first dispenser, said first injection system adding said first additive from said first dispenser to said first resultant solution to form a second resultant solution; and
h) a second injection system operatively connected to said second dispenser, said second injection system adding said second additive from said second dispenser to said first resultant solution to form a third resultant solution.

28. The apparatus of claim 27, wherein said product is in liquid form.

29. The apparatus of claim 27, wherein said first additive is in liquid form.

30. The apparatus of claim 29, further comprising a first reservoir in fluid communication with said first dispenser, wherein said first additive is stored in said first reservoir.

31. The apparatus of claim 27, wherein said second additive is in liquid form.

32. The apparatus of claim 31, further comprising a second reservoir in fluid communication with said second dispenser, wherein said second additive is stored in said second reservoir.

33. The apparatus of claim 27, wherein said first additive product and said second additive product are selected from the group consisting of a dye, a fragrance, and an ultraviolet protectant.

34. A method for dispensing and applying a dye with a finish product onto a surface of a vehicle in a vehicle wash station, comprising:
a) providing a first container holding a finish product solution;
b) providing a second container holding a dye solution;
c) combining water with said finish product solution to create a first resultant solution;
d) combining said first resultant solution with said dye solution to create a second resultant solution; and
e) applying said second resultant solution onto the vehicles in the vehicle wash station.

35. The method of claim 34, further comprising:
a) providing a third container holding a second dye solution;
b) combining said first resultant solution with said second dye solution to create a third resultant solution; and
c) applying said third resultant solution onto the vehicles in the vehicle wash station.

36. The method of claim 35, wherein said second resultant solution and said third resultant solution are pulsated intermittently.

37. The method of claim 35, wherein said second resultant solution and said third resultant solution are applied concurrently.

38. An apparatus for dispensing a dye with a base product, comprising:
a) a product container holding a base product;
b) a first dye container holding a first dye;
c) a first dye injector;
d) a water source, wherein water from said water source combines with said base product to create a first resultant solution;
e) a pump, said pump pumping said first resultant solution to said first dye injector, wherein said first dye from said first dye container combines with said first resultant solution to create a second resultant solution; and
f) an application member, said application member applying said second resultant solution onto vehicles in a vehicle wash station.

39. The apparatus of claim 38, further comprising:
a) a second dye container holding a second dye;
b) a second dye injector; and
c) a second pump, wherein said second pump pumps said first solution to said second dye injector, and wherein said second dye from said second dye container combines with said first resultant solution to create a third resultant solution, said third resultant solution being applied onto vehicles in the vehicle wash station by said application member.
